(19) United States
(12) Patent Application Publication
(10) Pub. No.: US 2025/0217718 A1
(43) Pub. Date: Jul. 3, 2025

(54) ENSEMBLE SUPERPIXEL BASED COMPRESSION COMPLEXITY REDUCTION

(71) Applicant: Cisco Technology, Inc., San Jose, CA (US)

(72) Inventors: Eric S. Liang, San Francisco, CA (US); Juan Carlos Zuniga, Montreal (CA); Matthew A. Silverman, Shaker Heights, OH (US); Qihong Shao, Clyde Hill, WA (US)

(73) Assignee: Cisco Technology, Inc., San Jose, CA (US)

(21) Appl. No.: 18/955,643

(22) Filed: Nov. 21, 2024

Related U.S. Application Data
(60) Provisional application No. 63/616,550, filed on Dec. 30, 2023.

(51) Int. Cl. G06N 20/20; H04B 7/06

(52) U.S. Cl. CPC G06N 20/20; H04B 7/0639

(57) ABSTRACT

Compression complexity reduction and, specifically, superpixel clustering, ensemble learning, and autoencoders for reducing feedback compression complexity may be provided. Compression complexity reduction can include receiving a Null Data Packet (NDP) from an Access Point (AP). A feedback matrix is generated in response to receiving the NDP. One or more superpixel cluster configurations are determined for the feedback matrix using an ensemble learning technique. A compressed matrix is generated based on the one or more superpixel cluster configurations and using an autoencoder, and the compressed matrix is sent to the AP.

### RELATED APPLICATION

Under provisions of 35 U.S.C. § 119 (e), Applicant claims the benefit of and priority to U.S. Provisional Application No. 63/616,550, filed Dec. 30, 2023, the disclosure of which is incorporated herein by reference in its entirety.

### TECHNICAL FIELD

The present disclosure relates generally to providing compression complexity reduction and specifically to providing superpixel clustering, ensemble learning, and autoencoders for reducing feedback compression complexity.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for compression complexity reduction in accordance with aspects of the present disclosure.

FIG. 2 is a block diagram of an ensemble learning, superpixel based, compression complexity reduction architecture in accordance with aspects of the present disclosure.

FIG. 3 is a block diagram of superpixel cluster configuration generation in accordance with aspects of the present disclosure.

FIG. 4 is a block diagram of loss propagation architecture in accordance with aspects of the present disclosure.

FIG. 5 is a block diagram of a compressed beamforming feedback frame in accordance with aspects of the present disclosure.

FIG. 6 is a block diagram of a Null Data Packet Announcement (NDPA) frame in accordance with aspects of the present disclosure.

FIG. 7 is a flow chart of a method for superpixel clustering and compression training in accordance with aspects of the present disclosure.

FIG. 8 is a flow chart of a method for compression complexity reduction in accordance with aspects of the present disclosure.

FIG. 9 is a block diagram of a computing device in accordance with aspects of the present disclosure.

FIG. 10 is a block diagram of a communications device in accordance with aspects of the present disclosure.

### DETAILED DESCRIPTION

### Overview

Compression complexity reduction and, specifically, superpixel clustering, ensemble learning, and autoencoders for reducing feedback compression complexity may be provided. Compression complexity reduction can include receiving a Null Data Packet (NDP) from an Access Point (AP). A feedback matrix is generated in response to receiving the NDP. One or more superpixel cluster configurations are determined for the feedback matrix using an ensemble learning technique. A compressed matrix is generated based on the one or more superpixel cluster configurations and using an autoencoder, and the compressed matrix is sent to the AP.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wireless Access Points (APs) can beamform transmissions to Stations (STAs) to enhance a wireless network (e.g., Wireless Local Area Network (WLAN)) by improving the signal strength and stability of the connection to signals and reducing potential interference. An AP can perform sounding to determine the location of STAs for beamforming by transmitting a Null Data Packet Announcement (NDPA) frame followed by a Null Data Packet (NDP). The receiving STA then uses the NDP to generate a feedback matrix (e.g., including Channel State Information (CSI)). The STA can apply a compression scheme on the feedback matrix and send the compressed feedback matrix to the AP in a beamforming report frame.

Existing compression schemes STAs use to compress feedback matrices may comprise manual, pre-specified rotations, but a complex compression scheme can negatively impact the power consumption and the processing time, introducing latency, for feedback matrix compression. The computational complexity of the feedback compression can also significantly increase when there are many transmitter antennas and spatial streams. Thus, the determination and compressions of the feedback can take unnecessary time and use unnecessary resources, degrading network performance.

To reduce the processing time of feedback matrices, an efficient compression scheme can be determined, such as by identifying key components of the feedback matrix and compressing the feedback matrix into the key components. In some embodiments, machine learning techniques can be used to determine which compression scheme to use to reduce latency by directly compressing the feedback matrix without the need of manual intervention or manually defined compression schemes. For example, superpixel clustering, ensemble learning, and/or autoencoders can be implemented to reduce the computational complexity of the feedback matrix compression without degrading the system throughput.

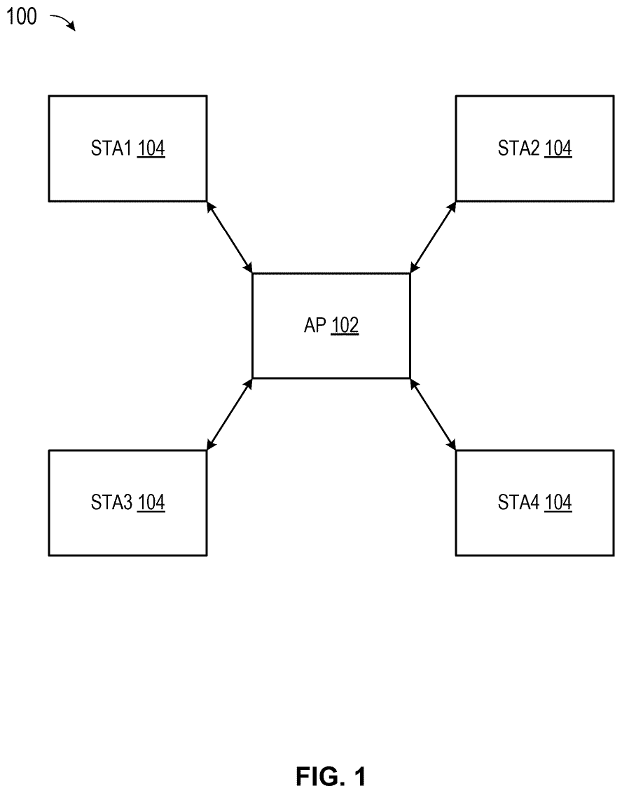

FIG. 1 is a block diagram of an operating environment 100 for compression complexity reduction. The operating environment 100 includes an AP 102 and STAs 104 (e.g., STA1, STA2, STA3, STA4). The AP 102 may enable devices within range of the AP 102, including the STAs 104, to connect to devices and applications of the network. The STAs 104 can be any device (e.g., a smart phone, a tablet, a personal computer, a server, etc.) that connects to the network. The operating environment 100 can comprise any number of APs 102 and/or STAs 104 in other embodiments.

The AP 102 can perform beamforming to direct transmissions to a specific recipient STA 104 to improve the signal strength and stability of the connection with the recipient STA 104 and reduce potential interference with the other STAs 104. To enable beamforming for a respective STA 104, the AP 102 can perform sounding with the respective STA 104 to receive compressed feedback and use the feedback to determine how to utilize its radios or otherwise operate to beamform the signal to the respective STA 104. However, as described above, compressing the feedback can be complex and negatively impact processing time and power consumption. The STAs 104 therefore can utilize superpixel clustering, ensemble learning, and autoencoders to reduce the computational complexity of the feedback matrix compression without degrading throughput.

Autoencoders include an encoder responsible for compressing the data and a decoder responsible for trying to reconstruct the data using the compressed data. Thus, using the encoder half of the autoencoder model, STAs 104 can use autoencoders to compress data. Autoencoder compression techniques can also be complex, however. Due to the complexity of the model, autoencoders can require a significant amount of time for training and for compressing new inputs. A large amount of input data can further exacerbate the complexity and efficiency problems of autoencoders. Thus, autoencoders alone may not sufficiently lower the complexity of compressing feedback matrices. For example, superpixel clustering can be performed to reduce the number of objects or data for compression.

Superpixel clustering is commonly used in computer vision environments where perceptually similar pixels in an image are grouped to create visually meaningful entities. The clustering enables the reduction of the number of objects or data for subsequent processing steps, thereby improving efficiency with little to no cost for accuracy. Superpixel clustering can be adapted for clustering matrix data, such as a feedback matrix, so the matrix's subcomponents are grouped into primary or important superpixel clusters for evaluation. However, current methods for determining superpixel clusters can be computationally complex and time consuming, so a more efficient method for determining superpixel clusters is described herein. For example, machine learning techniques, such as ensemble learning techniques, can be utilized to efficiently determine the superpixel clusters. Using autoencoders, superpixel clustering, and ensemble learning for reducing the complexity of feedback matrix compression will be described in further detail herein.

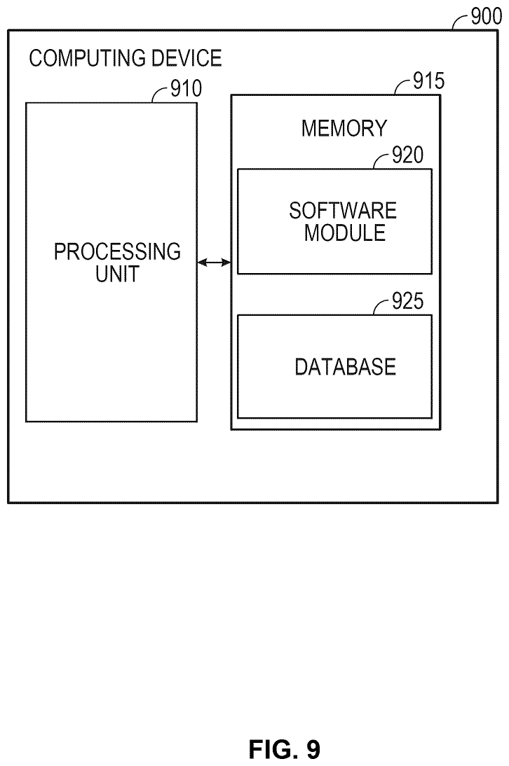

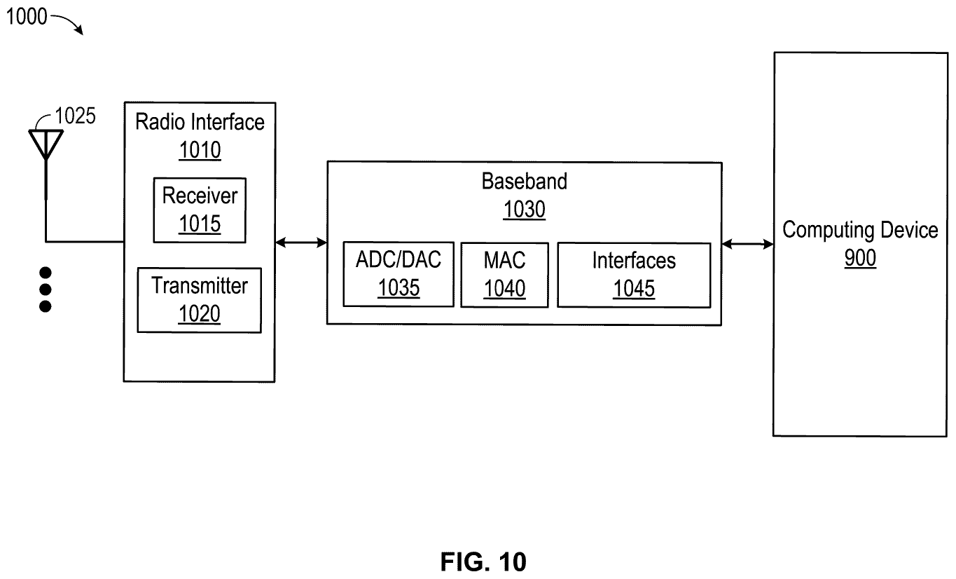

The elements described above of the operating environment 100 (e.g., the AP 102 the STAs 104, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 9 and 10, the elements of the operating environment 100 may be practiced in a computing device 900 and/or communications device 1000.

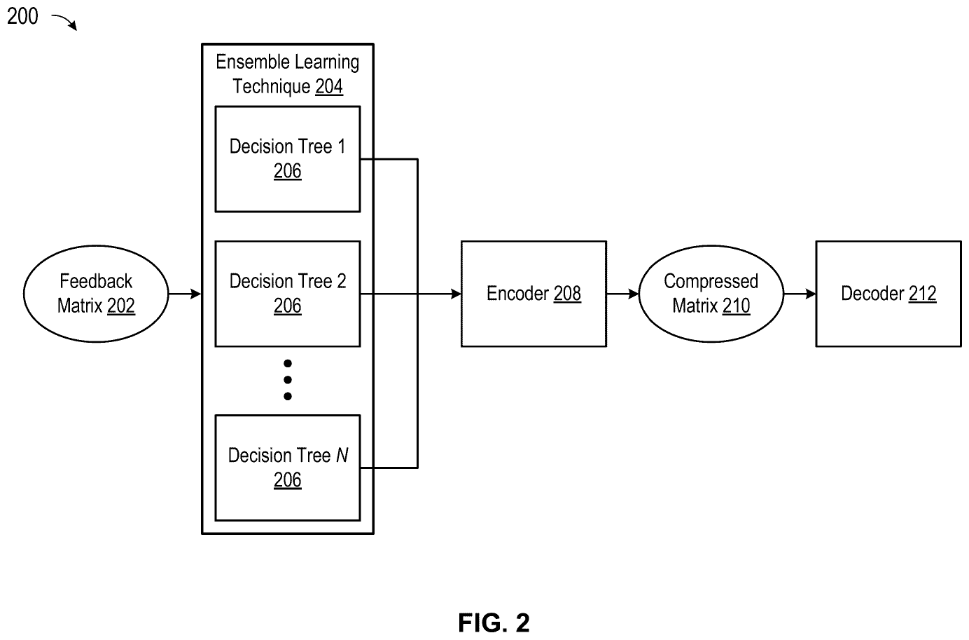

FIG. 2 is a block diagram of an ensemble learning, superpixel based, compression complexity reduction architecture 200. Devices, such as the STAs 104, can use the compression complexity reduction architecture 200 to compress feedback matrices with a lower complexity than typical techniques to reduce processing time and resource utilization because the compression complexity reduction architecture 200 uses autoencoders, superpixel clustering, and ensemble learning.

The compression complexity reduction architecture 200 includes inputting a feedback matrix 202 into an ensemble learning technique 204. A feedback matrix 202 comprising an array of data, and each data element in the array can be referred to as a cell. The ensemble learning technique 204 may include multiple decision trees 206 (e.g., decision tree 1, decision tree 2, decision tree N), and each decision tree 206 can generate superpixel clusters of the cells for reducing the complexity of subsequent operations. Thus, the ensemble learning technique 204 can generate multiple superpixel cluster configurations for the feedback matrix 202. The decision trees 206 can be weighted to output the most effective superpixel clusters for compression, and the weights can be based on the training of the ensemble learning technique 204. There may be no constraints on the size and shape of the superpixel clusters of cells. However, to increase the flexibility of the ensemble learning technique 204 for tailoring to multiple different problem settings, users (e.g., the STAs 104) can specify certain constraints regarding size and shape of the superpixel clusters.

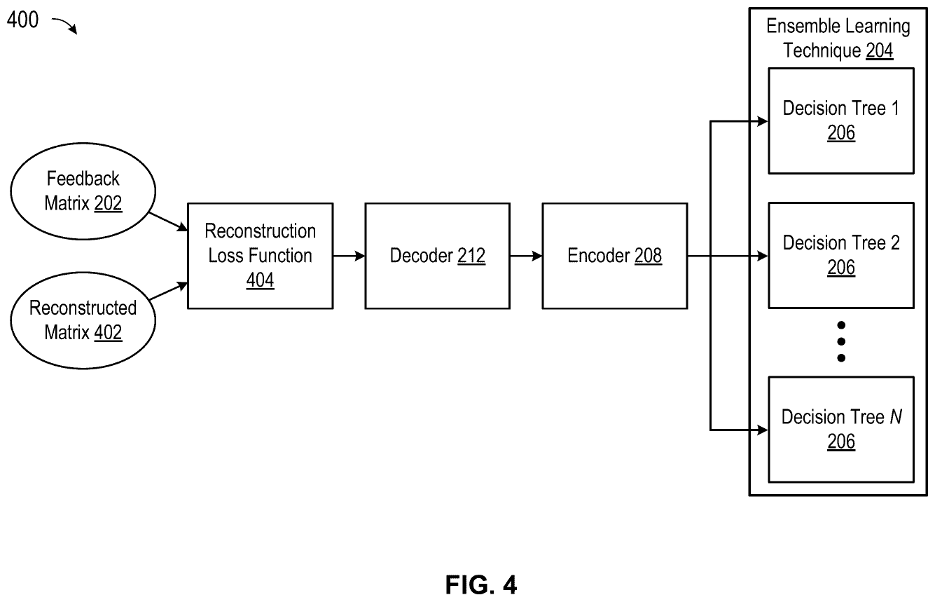

The ensemble learning technique 204 can determine one or more superpixel cluster configurations for the input feedback matrix 202, including the size (e.g., number of cells) and the shape of each superpixel cluster. To determine the superpixel cluster configurations, the ensemble learning technique 204 can comprise a random forests method. A random forests method can be utilized for its efficiency and speed when forming different combinations and decisions. The ensemble learning technique 204 can also be trained using a loss function, such as a Gini function, without a specified a max depth, so all possible combinations and layouts of superpixel clusters can be properly considered. When training the final loss for the ensemble learning technique 204, the ensemble learning technique 204 can utilize the loss at the end of the autoencoder as described in further detail below with respect to FIG. 4.

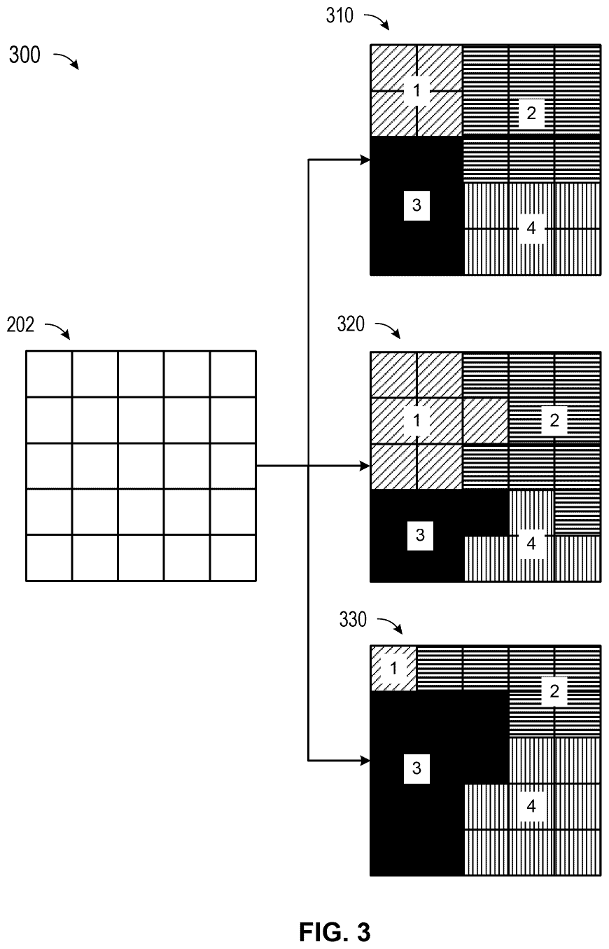

FIG. 3 is a block diagram of superpixel cluster configuration generation 300. As shown in FIG. 3, the feedback matrix 202 has five rows and five columns for a total of twenty-five cells, but the feedback matrix 202 can be any size in further embodiments. The ensemble learning technique 204 can generate one or more superpixel cluster configurations of the cells of the feedback matrix 202, such as a first superpixel cluster configuration 310, a second superpixel cluster configuration 320, and a third superpixel cluster configuration 330. In an example implementation, decision tree 1 206 generates the first superpixel cluster configuration 310, decision tree 2 206 generates the second superpixel cluster configuration 320, and decision tree N 206 generates the third superpixel cluster configuration 330. As illustrated, the first superpixel cluster configuration 310, the second superpixel cluster configuration 320, and the third superpixel cluster configuration 330 each have four superpixel clusters (denoted by 1, 2, 3, and 4) of various sizes and shapes. The ensemble learning technique 204 can generate superpixel cluster configurations with any number of superpixel clusters of any shape and size for the feedback matrix 202 in additional embodiments.

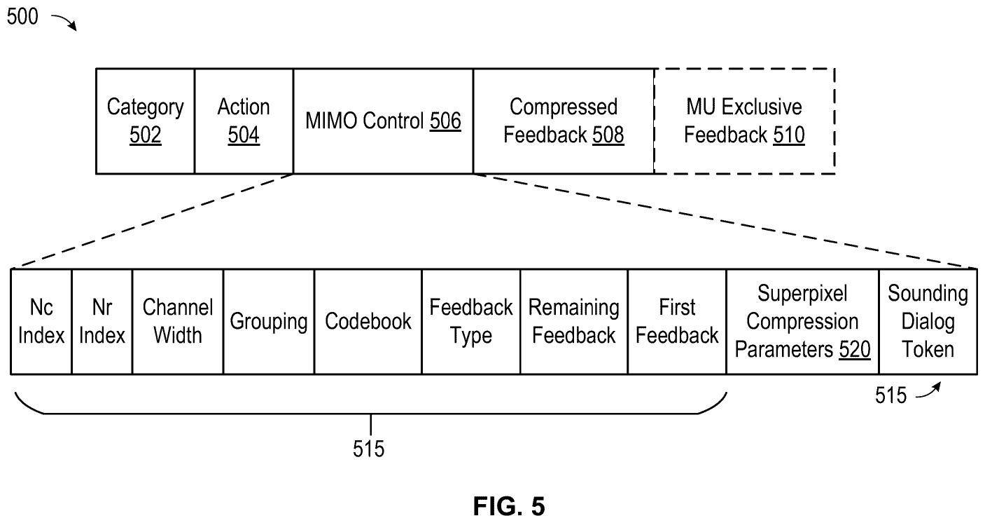

Referring back to FIG. 2, the ensemble learning technique 204 can output one or more generated superpixel cluster configurations (e.g., the first superpixel cluster configuration 310, the second superpixel cluster configuration 320, and/or the third superpixel cluster configuration 330) to an encoder 208, such as the encoder portion of an autoencoder. The encoder 208 is operable to compress the feedback matrix 202 using the received superpixel cluster configurations so that the compressed output is an accurate compression of the original feedback matrix 202. Thus, the encoder 208 outputs a compressed matrix 210 representing the feedback matrix 202. The STA 104 can then send the compressed matrix 210 to the AP 102. In some embodiments, the STA 104 sends the compressed matrix 210 using a new compressed beamforming feedback frame as will be described herein with respect to FIG. 5.

The compressed matrix 210 can also be input into a decoder 212 to determine whether the compressed matrix 210 accurately represents the feedback matrix 202. The encoder 208 and the decoder 212 can be components of an autoencoder. In some embodiments, a STA 104 inputs the compressed matrix 210 into the decoder 212 and evaluates the accuracy of the compressed matrix 210 before sending the compressed matrix 210 to the AP 102. Thus, the STA 104 can avoid sending an inaccurate compressed matrix 210 and reinput the feedback matrix 202 into the ensemble learning technique 204 for the encoder 208 to subsequently regenerate the compressed matrix 210. The STA 104 can also input the compressed matrix 210 into the decoder 212 to train the ensemble learning technique 204 and/or the encoder 208 to increase the accuracy of representing the feedback matrix 202 with the generated compressed matrix 210.

FIG. 4 is a block diagram of loss propagation architecture 400. The loss propagation architecture 400 can be utilized to determine the accuracy of matrix compression using the ensemble learning technique 204 and the encoder 208. The loss propagation architecture 400 can include inputting the feedback matrix 202 and a reconstructed matrix 402 into a reconstruction loss function 404. The reconstructed matrix 402 can be generated by the decoder 212 trying to reproduce the feedback matrix 202 using the compressed matrix 210, for example as described above with respect to the compression complexity reduction architecture 200. The reconstruction loss function 404 is a Gini loss function in some embodiments.

The reconstruction loss function 404 can compare the feedback matrix 202 and the reconstructed matrix 402 to determine the accuracy of the compressed matrix 210 and generate a loss value indicating said accuracy. The reconstruction loss function 404 can send the loss value or otherwise send the determined accuracy to the decoder 212, the encoder 208, and the ensemble learning technique 204 for backpropagation training to automatically adjust weights for the ensemble learning technique 204 for the decision trees 206 to generate better superpixel cluster configurations for compression and/or the encoder 208 to use a better compression technique for generating the compressed matrix 210. For example, the ensemble learning technique 204 can assign higher weight to decision trees 206 that generate superpixel cluster configurations that are result in an accurate reconstructed matrix 402 (e.g., the reconstructed matrix 402 including the information of the feedback matrix 202). The encoder 208 can also assign higher weight to parameter configurations in the autoencoder that result in an accurate reconstructed matrix 402.

Before implementation in a network, the ensemble learning technique 204 and the autoencoder (i.e., the encoder 208 and the decoder 212) can use the loss propagation architecture 400 for a training data set of feedback matrices 202 and evaluate each generated reconstructed matrix 402 from the superpixel cluster configuration the ensemble learning technique 204 outputs. The ensemble learning technique 204 and/or the autoencoder may then be assigned weights for compressing feedback with a high enough level of accuracy for devices (e.g., the AP 102) to effectively perform beamforming and/or the like. Because the loss determination backpropagates through to the ensemble learning technique 204, training may have a lower complexity (e.g., less computation required compared to using multiple loss propagation) while enabling a high enough level of accuracy for performing beamforming and/or the like.

FIG. 5 is a block diagram of a compressed beamforming feedback frame 500. STAs 104 can use the compressed beamforming feedback frame 500 to send compressed feedback to the AP 102. The compressed beamforming feedback frame 500 can include a category field 502, an action field 504, a Multiple Input Multiple Output (MIMO) control field 506, a compressed feedback field 508, and a Multiple User (MU) exclusive feedback field 510. The category field 502 can indicate the category of the compressed beamforming feedback frame 500 (e.g., Very High Throughput). The action field 504 can indicate the action the compressed beamforming feedback frame 500 is performing (e.g., carrying compressed feedback). The compressed feedback field 508 can include compressed feedback, such as the compressed matrix 210. The MU exclusive feedback field 510 may be present when MU beamforming is being performed, and the MU exclusive feedback field 510 can include Signal-to-Noise Ratio (SNR) differences between subcarriers and can update the steering matrix when there are multiple recipients.

The MIMO control field 506 enables the AP 102 or another recipient to interpret the compressed feedback included in the compressed feedback field 508. For example, MIMO control subfields 515 can include an Nc Index field indicating the number of columns in the feedback matrix, a Nr Index field indicating the number of rows in the feedback matrix, a channel width field to indicate the width of the underlying channel, a grouping field to indicate whether spatial streams are grouped together, a codebook field to describe the phase shifts required by each antenna element, a feedback type field to indicate single user or MU, flow control fields (e.g., a remaining feedback segments field, a first feedback segment field, and a sounding dialog token field for matching the response from the STA 104 to the request of the AP 102), and/or the like. The MIMO control field 506 can also include a superpixel compression parameters field 520. The superpixel compression parameters field 520 indicates parameters about the superpixel clustering and compression used, such as the compression technique, the type of technique the ensemble learning technique 204 uses, the weights assigned to the ensemble learning technique 204 and/or autoencoder, and/or the like.

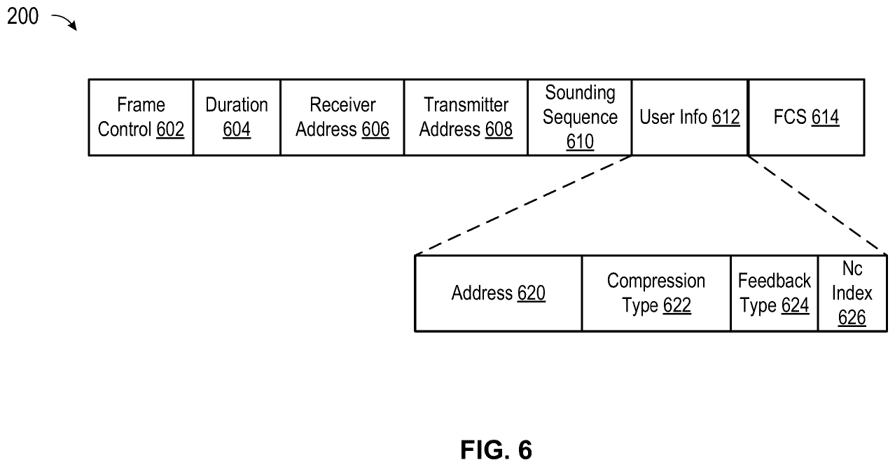

FIG. 6 is a block diagram of a NDPA frame 600. The AP 102 can send the NDPA frame 600 to STAs 104 to indicate announce channel sounding. Additionally, the NDPA frame 600 can indicate to STAs 104 to use superpixel clustering and compression (e.g., use the compression complexity reduction architecture 200).

The NDPA frame 600 can include a frame control field 602, a duration field 604, a receiver address field 606, a transmitter address field 608, a sounding sequence field 610, one or more user information fields 612, and a Frame Check Sequence (FCS) field 614. The frame control field 602 includes information about the NDPA frame 600, such as the type of frame, the data rate, the power management status, etc. The duration field 604 specifies the length of time that the channel will be occupied by sounding, including the transmission of the NDPA frame 600, transmitting one or more NDP frames, and receiving responses from the STAs (e.g., a compressed beamforming feedback frame 500).

The receiver address field 606 includes the recipient address (e.g., a Media Access Control (MAC) address) when the NDPA frame 600 includes a single user information field 612 or a broadcast address when the NDPA frame 600 includes multiple user information fields 612. For example, the receiver address field 606 may include the MAC address of an STA 104. The transmitter address field 608 includes the address of the device transmitting the NDPA frame 600. For example, the transmitter address field 608 may include the MAC address of the AP 102. The sounding sequence field 610 includes a sequence number associated with the current sounding sequence. The FCS field 614 includes an FCS-an error-detecting code that can be used to detect errors in a received NDPA frame 600.

Each user information field 612 can be intended for a recipient and indicate the feedback requested for sounding and the desired structure of the feedback matrix (e.g., the number of columns in the feedback matrix, compression to use, etc.). The user information field 612 can include an address field 620, a compression type field 622, a feedback type field 624, and a Nc Index field 626. The address field 222 may include an identifier, such as an Association Identifier or MAC address, of the intended recipient. The compression type field 622 can indicate the type of compression the recipient should use to compress the feedback. For example, the AP 102 can indicate in the compression type field 622 to perform superpixel clustering and compression or to otherwise use the compression complexity reduction architecture 200. The feedback type field 224 indicates the requested feedback type, such as single user or MU. The Nc index field 226 indicates the feedback matrix dimension requested. Thus, the recipient device can respond with data for sounding according to the feedback requested and with the desired or otherwise correct feedback matrix structure, including using superpixel clustering and compression (e.g., the compression complexity reduction architecture 200).

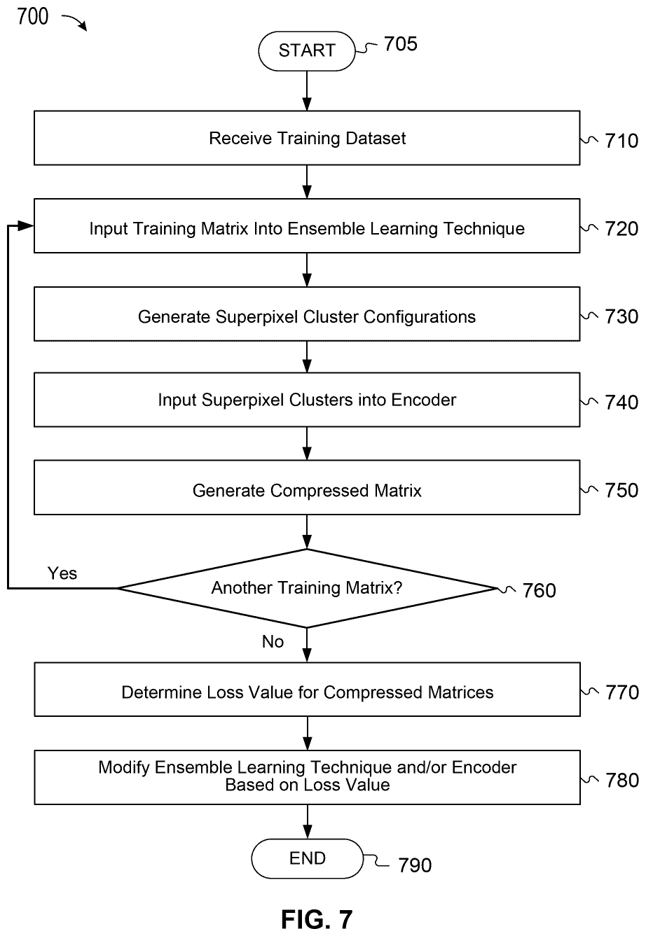

FIG. 7 is a flow chart of a method 700 for superpixel clustering and compression training. The method 700 can begin at starting block 705 and proceed to operation 710. In operation 710, a training dataset is received. The training dataset can comprise one or more training feedback matrices. In operation 720, a training matrix of the training dataset is input into the ensemble learning technique 204. In operation 730, the ensemble learning technique 204 generates one or more superpixel cluster configurations of the training matrix. In operation 740, the one or more superpixel cluster configurations are input into the encoder 208, and the encoder 208 generates a compressed matrix 210 in operation 750. In decision 760, if there is another training matrix in the training data set, the method 700 may proceed back to operation 720 for that next training matrix to have superpixel cluster configurations generated and then compressed.

When there are no training matrices remaining, the method 700 may proceed from decision 760 to operation 770. In operation 770, a loss value is determined for the compressed matrices generated in operation 750. For example, the compressed matrices 210 can be reconstructed into reconstructed matrices 402, and the reconstruction loss function 404 can generate the loss value or otherwise determine the accuracy of the reconstructed matrix 402 compared to the respective feedback matrix 202. In operation 780, the ensemble learning technique 204 and/or the encoder 208 are modified based on the loss values determined in operation 770. For example, the ensemble learning technique 204 and/or the encoder 208 can be assigned or otherwise determine weights. The method 700 can conclude at ending block 790.

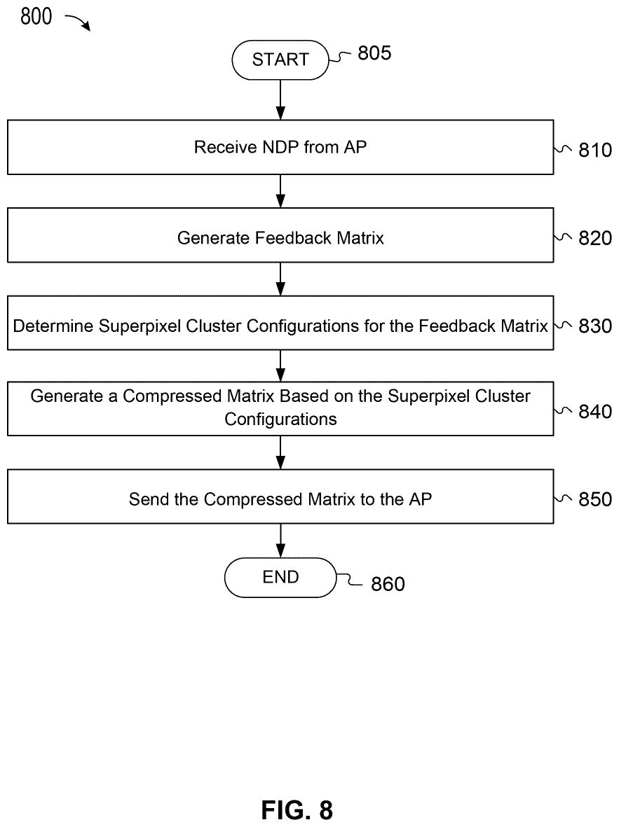

FIG. 8 is a flow chart of a method 800 for compression complexity reduction. The method 800 can begin at starting block 705 and proceed to operation 810. In operation 810, a NDP is received from an AP. For example, an STA 104 receives an NDP from the AP 102 to perform sounding. In some embodiments, the STA 104 can also receive an NDPA frame 600 comprising the compression type field 622 indicating to perform superpixel clustering and compression. In operation 820, a feedback matrix is generated in response to receiving the NDP. For example, the STA 104 generates the feedback matrix 202.

In operation 830, one or more superpixel cluster configurations are determined for the feedback matrix using an ensemble learning technique. For example, the STA 104 inputs the feedback matrix 202 into the ensemble learning technique 204, and the ensemble learning technique 204 determine on or more superpixel cluster configurations. The ensemble learning technique 204 can comprise a random forests method. In operation 840, a compressed matrix is generated based on the one or more superpixel cluster configurations and using an autoencoder. For example, the superpixel cluster configurations are input into the encoder 208, and the encoder 208 generates a compressed matrix 210. In operation 850, the compressed matrix is sent to the AP. For example, the STA 104 sends the compressed matrix 210 to the AP 102. Sending the compressed matrix 210 to the AP 102 can comprise sending a compressed beamforming feedback frame 500 comprising parameters about superpixel clustering and compression (e.g., in the superpixel compression parameters field 520) and the compressed matrix 212.

The method 800 can also include training the ensemble learning technique 204 and/or the autoencoder. For example, the training can comprise the operations of method 700. In some embodiments, the training comprises receiving one or more training matrices, determining training superpixel cluster configurations for the one or more training matrices using the ensemble learning technique 204, determining training compressed matrices using the training superpixel cluster configurations, determining loss values for the training compressed matrices, and modifying the ensemble learning technique 204 and/or the autoencoder (e.g., the encoder 208) based on the loss values.

In some embodiments, the method 800 includes generating a reconstructed matrix by decoding the compressed matrix using the autoencoder and determining an accuracy of superpixel clustering and compression by comparing the feedback matrix to the reconstructed matrix. In certain embodiments, the STA 104 can receive a beamformed transmission from the AP 102 based on the compressed matrix. The method 800 can conclude at ending block 860.

FIG. 9 is a block diagram of a computing device 900. As shown in FIG. 9, computing device 900 may include a processing unit 910 and a memory unit 915. Memory unit 915 may include a software module 920 and a database 925. While executing on processing unit 910, software module 920 may perform, for example, processes for compression complexity reduction and, specifically, superpixel clustering, ensemble learning, and autoencoders for reducing feedback compression complexity with respect to FIGS. 1-8. Computing device 900, for example, may provide an operating environment for the AP 102, the STAs 104, and the like. The AP 102, the STAs 104, and the like may operate in other environments and are not limited to computing device 900.

Computing device 900 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 900 may comprise any computer operating environment, such as hand-held devices, multiprocessor systems, microprocessor-based or programmable sender electronic devices, minicomputers, mainframe computers, and the like. Computing device 900 may also be practiced in distributed computing environments where tasks are performed by remote processing devices. The aforementioned systems and devices are examples, and computing device 900 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 900 on the single integrated circuit (chip).

FIG. 10 illustrates an implementation of a communications device 1000 that may implement one or more of the AP 102, the STAs 104, etc., of FIGS. 1-8. In various implementations, the communications device 1000 may comprise a logic circuit. The logic circuit may include physical circuits to perform operations described for one or more of the AP 102, the STAs 104, etc., of FIGS. 1-8, for example. As shown in FIG. 10, the communications device 1000 may include one or more of, but is not limited to, a radio interface 1010, baseband circuitry 1030, and/or the computing device 900.

The communications device 1000 may implement some or all of the structures and/or operations for the AP 102, the STAs 104, etc., of FIGS. 1-8, storage medium, and logic circuit in a single computing entity, such as entirely within a single device. Alternatively, the communications device 1000 may distribute portions of the structure and/or operations using a distributed system architecture, such as a client station server architecture, a peer-to-peer architecture, a master-slave architecture, etc.

A radio interface 1010, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 1010 may include, for example, a receiver 1015 and/or a transmitter 1020. The radio interface 1010 may include bias controls, a crystal oscillator, and/or one or more antennas 1025. In additional or alternative configurations, the radio interface 1010 may use oscillators and/or one or more filters, as desired.

The baseband circuitry 1030 may communicate with the radio interface 1010 to process, receive, and/or transmit signals and may include, for example, an Analog-To-Digital Converter (ADC) for down converting received signals with a Digital-To-Analog Converter (DAC) 1035 for up converting signals for transmission. Further, the baseband circuitry 1030 may include a baseband or PHYsical layer (PHY) processing circuit for the PHY link layer processing of respective receive/transmit signals. Baseband circuitry 1030 may include, for example, a MAC processing circuit 1040 for MAC/data link layer processing. Baseband circuitry 1030 may include a memory controller for communicating with MAC processing circuit 1040 and/or a computing device 900, for example, via one or more interfaces 1045.

In some configurations, PHY processing circuit may include a frame construction and/or detection module, in combination with additional circuitry such as a buffer memory, to construct and/or deconstruct communication frames. Alternatively or in addition, MAC processing circuit 1040 may share processing for certain of these functions or perform these processes independent of PHY processing circuit. In some configurations, MAC and PHY processing may be integrated into a single circuit.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
receiving a Null Data Packet (NDP) from an Access Point (AP);
generating a feedback matrix in response to receiving the NDP;
determining one or more superpixel cluster configurations for the feedback matrix using an ensemble learning technique;
generating a compressed matrix based on the one or more superpixel cluster configurations and using an autoencoder; and
sending the compressed matrix to the AP.

2. The method of claim 1, further comprising receiving a NDP Announcement (NDPA) frame from the AP, wherein the NDPA frame comprises a compression type field indicating to perform superpixel clustering and compression.

3. The method of claim 1, wherein sending the compressed matrix to the AP comprises sending a compressed beamforming feedback frame comprising parameters about superpixel clustering and compression and the compressed matrix.

4. The method of claim 1, further comprising training the ensemble learning technique and the autoencoder, the training comprising:
receiving one or more training matrices;
determining training superpixel cluster configurations for the one or more training matrices using the ensemble learning technique;
determining one or more training compressed matrices using the training superpixel cluster configurations;
determining one or more loss values for the one or more training compressed matrices; and
modifying, based on the one or more loss values, (i) the ensemble learning technique, (ii) the autoencoder, or (iii) both (i) and (ii).

5. The method of claim 1, further comprising:
generating a reconstructed matrix by decoding the compressed matrix using the autoencoder; and
determining an accuracy of superpixel clustering and compression by comparing the feedback matrix to the reconstructed matrix.

6. The method of claim 1, wherein the ensemble learning technique comprises a random forests method.

7. The method of claim 1, further comprising receiving a beamformed transmission from the AP based on the compressed matrix.

8. A system comprising:
a memory storage; and
a processing unit coupled to the memory storage, wherein the processing unit is operative to:
receive a Null Data Packet (NDP) from an Access Point (AP);
generate a feedback matrix in response to receiving the NDP;
determine one or more superpixel cluster configurations for the feedback matrix using an ensemble learning technique;
generate a compressed matrix based on the one or more superpixel cluster configurations and using an autoencoder; and
send the compressed matrix to the AP.

9. The system of claim 8, the processing unit being further operative to receive a NDP Announcement (NDPA) frame from the AP, wherein the NDPA frame comprises a compression type field indicating to perform superpixel clustering and compression.

10. The system of claim 8, wherein to send the compressed matrix to the AP comprises to send a compressed beamforming feedback frame comprising parameters about superpixel clustering and compression and the compressed matrix.

11. The system of claim 8, the processing unit being further operative to train the ensemble learning technique and the autoencoder, the training comprising to:
receive one or more training matrices;
determine training superpixel cluster configurations for the one or more training matrices using the ensemble learning technique;
determine one or more training compressed matrices using the training superpixel cluster configurations;
determine one or more loss values for the one or more training compressed matrices; and
modify, based on the one or more loss values, (i) the ensemble learning technique, (ii) the autoencoder, or (iii) both (i) and (ii).

12. The system of claim 8, the processing unit being further operative to:
generate a reconstructed matrix by decoding the compressed matrix using the autoencoder; and
determine an accuracy of superpixel clustering and compression by comparing the feedback matrix to the reconstructed matrix.

13. The system of claim 8, wherein the ensemble learning technique comprises a random forests method.

14. The system of claim 8, the processing unit being further operative to receive a beamformed transmission from the AP based on the compressed matrix.

15. A non-transitory computer-readable medium that stores a set of instructions which when executed perform a method executed by the set of instructions comprising:
receiving a Null Data Packet (NDP) from an Access Point (AP);
generating a feedback matrix in response to receiving the NDP;
determining one or more superpixel cluster configurations for the feedback matrix using an ensemble learning technique;
generating a compressed matrix based on the one or more superpixel cluster configurations and using an autoencoder; and
sending the compressed matrix to the AP.

16. The non-transitory computer-readable medium of claim 15, the method executed by the set of instructions further comprising receiving a NDP Announcement (NDPA) frame from the AP, wherein the NDPA frame comprises a compression type field indicating to perform superpixel clustering and compression.

17. The non-transitory computer-readable medium of claim 15, wherein sending the compressed matrix to the AP comprises sending a compressed beamforming feedback frame comprising parameters about superpixel clustering and compression and the compressed matrix.

18. The non-transitory computer-readable medium of claim 15, the method executed by the set of instructions further comprising training the ensemble learning technique and the autoencoder, the training comprising:
receiving one or more training matrices;
determining training superpixel cluster configurations for the one or more training matrices using the ensemble learning technique;
determining one or more training compressed matrices using the training superpixel cluster configurations;
determining one or more loss values for the one or more training compressed matrices; and
modifying, based on the one or more loss values, (i) the ensemble learning technique, (ii) the autoencoder, or (iii) both (i) and (ii).

19. The non-transitory computer-readable medium of claim 15, the method executed by the set of instructions further comprising:
generating a reconstructed matrix by decoding the compressed matrix using the autoencoder; and
determining an accuracy of superpixel clustering and compression by comparing the feedback matrix to the reconstructed matrix.

20. The non-transitory computer-readable medium of claim 15, wherein the ensemble learning technique comprises a random forests method.
